(19) United States
(12) Patent Application Publication
(10) Pub. No.: US 2009/0162626 A1
(43) Pub. Date: Jun. 25, 2009

(54) CONCRETE HAVING EXCELLENT EXPLOSION RESISTANCE

(75) Inventors: Takuya Konishi, Ohtsu-shi (JP); Tokuichi Maeda, Ohtsu-shi (JP); Kiyosuke Kamiyama, Ohtsu-shi (JP)

Correspondence Address: MORRISON & FOERSTER LLP, 1650 TYSONS BOULEVARD, SUITE 400, MCLEAN, VA, 22102, US

(73) Assignee: Toyo Boseki Kabushiki Kaisha, Osaka-shi (JP)

(21) Appl. No.: 12/298,888

(22) PCT Filed: Apr. 27, 2007
(86) PCT No.: PCT/JP2007/059181

§ 371 Date: Oct. 28, 2008

(30) Foreign Application Priority Data
Apr. 28, 2006 (JP) 2006-125720

(51) Int. Cl. B32B 13/02; C04B 32/00; B32B 7/02

(52) U.S. Cl. 428/212; 106/638; 428/688

(57) ABSTRACT

This invention provides a concrete having excellent exploding resistance, comprising a fiber as one constituent material, wherein said concrete has a compressive strength of 50 N/mm² or more, a bending strength of 6 N/mm² or more, and a ratio of the bending strength to the compressive strength is 15 or less. Upon explosion of an explosive material near a structure, a part of the structure is separated by explosion energy. In general, the separation of the structure on the side opposite to the side facing explosion is larger than that of the side facing explosion, it could trigger collapse of concrete, and the separation on this side has a larger risk of injuring persons within the structure. Since the present invention has the effect of reducing a separated volume, it can be used for various structures as a concrete for lifesaving or for preventing the collapse of the structure.

### REFERENCE TO RELATED APPLICATIONS

This application is a national stage application under 35 USC 371 of International Application No. PCT/JP2007/059181, filed Apr. 27, 2007, which claims the priority of Japanese Patent Application No. 2006-125720, filed Apr. 28, 2006, the contents of which prior applications are incorporated herein by reference.

### FIELD OF THE INVENTION

The present invention relates to a concrete having excellent exploding resistance for the purpose of preventing the destruction of concrete members by blasting of explosives, for example, preventing the collapse of structures by blasting or rocket bomb by the acts of terrorism targeting public structures, and further for the purpose of saving lives of persons within the structures.

### BACKGROUND OF THE INVENTION

In recent years, disputes break out around the world because of confrontations among nations, between the religions, or between races, and measures such the destruction of a structure by blasting by the use of explosives such as bombs or the like are taken as one of attack. The attack is not limited to the military and is often targeted at a private sector. Upon explosion of an explosive material near a concrete, the surface on the explosion side and the surface on the opposite side of the concrete are partially separated by explosion energy. The flying speed of broken pieces at that time is very fast and poses a hazard which could injure persons. Further, in the worst case, if the volume of a separated portion is large, a force binding main reinforcing rods is lost, and therefore this may lead to the destruction of structures.

Upon investigation of patents concerning the hitherto proposed concretes or mortars having exploding resistance, many ideas for solving a problem that a high-strength concrete causes vapor explosion due to fire, or the like, are proposed (for example, Japanese Unexamined Patent Publication No. 2002-193654, Japanese Unexamined Patent Publication No. 2002-326857, Japanese Unexamined Patent Publication No. 2004-026631, etc.).

However, these proposals are means for preventing a structure from being destroyed by a process in which water existing within a concrete becomes steam due to fire and the volume of the steam is expanded to explode with time, and are not proposals of a method for preventing the destruction of a structure by the explosion of explosives, and performance in blasting of explosives is not described clearly in Examples of these inventions.

As for another object, there are proposals of imparting explosion-resistant performance to protect a structure from the destruction against a rapid impact by an earthquake (for example, Japanese Unexamined Patent Publication No. 2000-192671, Japanese Unexamined Patent Publication No. 11-036516). These proposals are also means for preventing a structure from being destroyed by an earthquake, and are not proposals of a method for preventing the destruction of a structure by the explosion of explosives, and performance in blasting of explosives is not described clearly in Examples of these inventions.

Further, in Japanese Unexamined Patent Publication No. 10-512842, a composite concrete having excellent protection performance against impacts, shocks or projectile is proposed. However, in Examples of this proposal, a bullet is shoot into a test specimen and the depth of penetration has been measured, and therefore this is not a proposal from the viewpoint of the destruction of structures associated with the explosion of explosives and its effect is not shown clearly.

A proposal of intellectual property concerning exploding resistance performance against the explosion of a concrete with explosives is not made, but various experiments are carried out in the Defense Agency, and the like, and many reports on the results thereof are published (Journal of Structural Engineering, 46A, pp. 1787-1797, 2000, Concrete Research and Technology, Vol. 14, No. 1, 2003). In these reference, the following relational expression among a thickness T (cm) of a concrete plate, an explosive amount W (g) of a high explosive, a depth Cd (cm) of separation on the side on which the high explosive is set up after a blasting test, and a depth Sd (cm) of separation on the opposite side of the side on which the high explosive is set up:

(Cd+Sd)/T<−0.51×(T/W^{1/3})+2.1(2.1≦T/W^{1/3}≦3.6) (1),

Sd/T=0(T/W^{1/3}≧3.6) (2), and

(Cd+Sd)/T=1.0(T/W^{1/3}<2.1) (3),

is given.

In the above expression, the expression (2) indicates that the depth of separation on the side and the opposite side of the side, on which the high explosive is set up, is “zero”, that is, there is no damage, and the expression (3) indicates that inversely, there is such a large damage that a through hole is produced.

### SUMMARY OF THE INVENTION

The present invention has been made in view of the above state, and it is an object of the present invention to provide a concrete which can suppress extensive destruction of a structure by explosion by the use of explosives and prevent injuries of persons within the structure through suppressing the flying of concrete broken pieces by a blasting impact.

Further, it is also an object of the present invention to provide a structure in which the weight of the structure can be reduced by the use of a thin concrete plate having excellent exploding resistance and adequate exploding resistance can be realized by stacking the thin concrete plates.

The present invention which can solve the above problem pertains to a concrete having excellent exploding resistance, including a fiber as one constituent material, wherein the concrete has a compressive strength of 50 N/mm² or more and a bending strength of 6 N/mm² or more, and a ratio of the compressive strength to the bending strength is 15 or less.

In the present invention, a concrete obtained by mixing high-strength fibers has the effect of reducing the destroyed volume of the concrete in the explosion by the use of explosives. More specifically, upon explosion of an explosive material near a structure, a part of the structure is separated by explosion energy. In general, the separation of the structure on the side opposite to the side facing explosion is larger than that on the side facing the explosion, and the separation on this side has a larger risk of injuring persons within the structure. Since the present invention has the effect of reducing the separated volume in the acts of blasting a concrete structure using explosives such as terrorism, it can be used as a member for lifesaving or for preventing the collapse of the structure.

### BRIEF DESCRIPTION OF THE DRAWINGS

FIG. 1 is an illustrative view showing dimensions of a test specimen.

FIG. 2 is an illustrative view showing a method of a blasting test.

FIG. 3 is a view illustrating a specimen, a crater and a spall after a blasting test.

FIG. 4 is a graph showing a relation expression between the depth of concrete separation and the amount of explosives.

### DETAILED DESCRIPTION OF THE INVENTION

When a high explosive is exploded near a concrete plate, in the concrete plate, not only on the side of facing explosion but also on the side opposite to the side facing explosion, damages (separation of a concrete) occur. The magnitude of the damages at this time depends on the thickness of the concrete plate and the amount of the explosives. The present invention proposes a concrete plate which hardly sustains damage or sustains less damage compared with a conventional concrete.

As described above, the following relational expression:

(Cd+Sd)/T<−0.51×(T/W^{1/3})+2.1,

is given among a thickness T (cm) of the concrete plate, an explosive amount W (g) of a high explosive, a depth Cd (cm) of separation on the side on which the high explosive is set up after a blasting test, and a depth Sd (cm) of separation on the opposite side of the side on which the high explosive is set up. In the concrete plate of the present invention, the thickness of the plate and the explosive amount, which satisfy the above relational expression, respectively, are in a range where the relational expression of 0.5≦T/W^{1/3}≦2.5 holds. In the conventional reinforced concrete plate, the thickness of the plate and the explosive amount are in a range of 2.1≦T/W^{1/3}≦3.6, and therefore it is shown that the concrete of the present invention needs a more explosive amount than the conventional concrete if the thicknesses of the plates are the same. In other words, in order to cause the same damage, a more explosive amount is required or a thickness of the concrete of the present invention can be lower than that of the conventional concrete plate. The concrete obtained in accordance with the present invention can be used as a member for preventing the collapse of the structure or can achieve an effect of reducing the weight of the structure by thinning the wall thickness of the structure.

Hereinafter, the present invention will be described in detail. In addition, properties of the concrete of the present invention are properties of the concrete which has been cured for 28 days or more.

The present invention is characterized by reducing the separated volume of a concrete by the blasting by mixing high-strength fibers in the concrete. The concrete is intrinsically superior in compressive performance, but it is fairly low in tensile performance including strength and strain at break. However, the concrete of the present invention has a high compressive strength and a high tensile strength.

The concrete of the present invention needs to has a compressive strength of 50 N/mm² or more and a bending strength of 6 N/mm² or more. When an explosive is exploded, it is considered that an excessive pressure is produced at a location which the explosive is in contact with. The concrete requires a compressive strength of such a level that the concrete can resist this pressure and the concrete facing the explosion is not destroyed. The concrete of the present invention exhibits a compressive strength of 50 N/mm² or more. A more preferable compressive strength is 55 N/mm² or more. Further, it is considered that a pressure produced by the explosion propagates through the inside of the concrete and reaches a backside of the concrete (the side opposite to the side on which the explosive is set up). It is considered that a tensile action is generated on the opposite side of the concrete. Therefore, the concrete requires a bending strength of such a level that the concrete can resist this tension and the opposite concrete is not destroyed. The concrete of the present invention exhibits a bending strength of 6.0N/mm² or more. A more preferable bending strength is 8.0 N/mm² or more. In order to prevent both sides of the concrete from being destroyed due to the explosion of an explosive, it is necessary that both the compressive strength and the bending strength are large and it is essential to have an excellent balance between the compressive strength and the bending strength. Specifically, it is desired that a ratio of the compressive strength to the bending strength is at least 15 or less and preferably 10 or less. When this ratio is more than 15, the destruction of the surface on which the explosive is set up or the opposite surface thereof becomes large and may lead to the collapse of the structures.

The performance of such a concrete having excellent exploding resistance is specifically described. When 100 g of an explosive is placed so as to be in direct contact with the surface of the concrete prepared according to the present invention and exploded, the depth of a separated concrete can be limited to half of the original thickness of the concrete. Further, it is preferable that the diameter of a separated area is 150 mm or less on the side on which the explosive is set up and 200 mm or less on the opposite side thereof, and a separated volume is 150 cm³ or less on the side on which the explosive is set up and 500 cm³ or less on the opposite side thereof.

The concrete of the present invention preferably has a bending toughness of 25 kN·mm or more. When the concrete is exploded, the separated volume of the opposite surface of the surface on which the explosive is set up is larger than that of the surface on which the explosive is set up. It is predicted that the bending action or a tensile action is generated on the opposite surface at which the size of separation is large. Accordingly, a concrete having a large bending bearing strength and high toughness after destruction can reduce a separated volume because the ability of the concrete to follow a large deformation is high.

As cement used for the concrete, regular Portland cement, high early strength Portland cement, super high early strength Portland cement, moderate Portland cement and the like can be used, but the cement is not limited to the above cements and various cements can be used. The concrete of the present invention is obtained by adding publicly known fine aggregates and coarse aggregates, water and fibers described later, to the cement in an appropriate amount, respectively, to be kneaded, and molding (casting) and curing the resulting mixture. Further, fly ash, silica, blast furnace slag powder or the like can be used in order to enhance the fluidity of concrete paste and achieve a concrete strength.

It is preferable that the amount of fibers to be mixed is larger in order to decrease the separated volume of a concrete, but there is a problem that the fluidity of concrete paste is deteriorated. In order to secure the fluidity of concrete paste, a high-performance AE water reducing agent or the like can be added.

In the present invention, fibers to be mixed in a concrete preferably has a tensile strength of 1.5 GPa or more and a tensile modulus of elasticity of 40 GPa or more. That the concrete is separated by the explosion of explosives is considered to be due to the occurrence of a rapid tension or shear force at an interface between a separated portion and a substrate by the explosion. Since the concrete is very low in tensile strength, it is necessary to increase a resisting power against the tension by fibers. When the tensile strength of the fiber used then is low, the fiber is readily cut and cannot prevent the concrete from being separated. Therefore, the tensile strength of the fiber is preferably 1.5 GPa or more, and more preferably 1.9 GPa or more.

Further, since the limit strain of the concrete is extremely low, if the tensile modulus of elasticity of the fiber used is low, the fiber cannot exert an effect of inhibiting the deformation of the concrete within a region of the limit strain and cannot prevent the separation or the collapse of the concrete. When the modulus of elasticity of the fiber is high, the fiber can exert an effect of inhibiting the deformation of the concrete and can reduce the separated volume. Thus, the tensile modulus of elasticity of the fiber is preferably 40 GPa or more, and more preferably 70 GPa or more.

In order to enhance exploding resistance, it is necessary that fibers exist uniformly within a concrete and exist at any cross section. In the case of one concrete, the fibers preferably exist in an amount of 2.0 vol. % or more to inhibit the separation by explosion. In the case of a concrete complex described later, if the fibers exist in an amount of 1.0 vol. % or more, an effect of inhibiting the separation is seen. In any case, the content of the fibers is preferably limited to 8.0 vol. % or less per cubic meter of a concrete since a too large amount of fibers causes shots or cohesion during kneading of a concrete, leading to low workability. The more preferable amount of fibers is 2.0 to 6.0 vol. %.

The configuration of the fiber is not particularly limited, but a shape having a high adhesive force between a concrete substrate and the fiber is preferable. For example, fibers formed by bundling several hundreds to several thousands single fibers of a high-strength fiber satisfying the above strength range together, and winding a thermally adhesive yarn around the bundle in order to fasten the bundle, and heat treating the bundle to fasten the fibers are preferable. Hereinafter, a set of fibers having this configuration is referred to as a fiber composite. The reason why this fiber composite is preferable is that when this fiber composite is used, concrete paste penetrates into a bundle of high-strength fibers through an area which is not covered with the thermally adhesive yarn to produce a firm binding force. In addition, since the fiber composite inherits properties of a high strength fiber, the tensile strength is 1.5 GPa or more and the tensile modulus of elasticity is 40 GPa or more.

The diameter of the high strength fiber in the fiber composite is preferably 300 dtex or more and 20000 dtex or less in a state of bundling several hundreds to several thousands fibers together. When the diameter is 300 dtex or less, fiber cost becomes expensive and an economical problem arises. When the diameter is 20000 dtex or more, it becomes difficult to wind a thermally adhesive yarn around the bundle. The diameter of the thermally adhesive yarn is preferably 100 dtex or more and 2000 dtex or less. Further, the number of turns of winding the thermally adhesive yarn around the high-strength fibers is preferably 50 turns/m or more and 500 turns/m or less. When the number of turns of winding is 50 turns/m or less, it becomes difficult to maintain the configuration of the high-strength fiber bundle, and when the number of turns of winding is 500 turns/m or more, an exposed portion of the high-strength fibers is small, and an adhesive force to the concrete is hardly achieved.

In the fiber composite, the ratio of fineness of the high-strength fiber bundle to fineness of the thermally adhesive yarn is preferably 3:1 to 5:1. Further, the space between winding turns is preferably 3 mm or more and 10 mm or less in terms of a space between adjacent thermally adhesive yarns. The reason for this is that in mixing with powder or kneading in the concrete paste, a state of fibers can be maintained and cement paste easily flows into the fiber composite. When the ratio of fineness of the high-strength fiber bundle to fineness of the thermally adhesive yarn is less than 3:1, the content of the high-strength fiber is small to lower an effect of reinforcing. When the ratio is larger than 5:1, the thermally adhesive yarn and an aggregate rub against each other in kneading, and the thermally adhesive yarn is cut off, and there may be a possibility where the configuration of the fiber composite cannot be maintained. Further, if the space between winding turns is within the above range, materials having a small particle size such as fine aggregate, cement, blast furnace slag powder and the like can pass through between the thermally adhesive yarns and penetrate into the high-strength fiber bundle. However, when the space between the thermally adhesive yarns is less than 3 mm, the fine aggregate or the like hardly penetrate into the high-strength fiber bundle, and when the space is more than 10 mm, it is not preferable since it becomes difficult to maintain the configuration of the fiber composite.

The cross-sectional area of the fiber composite is preferably 10000 μm² or more at a portion around which the thermally adhesive yarn is wound, and more preferably 50000 μm² or more. When the cross-sectional area is less than 10000 μm², the fiber composites may be entangled with one another during kneading to form a ball-like fibers, and in this state, an effect of adding fibers can be hardly exerted, and in addition, this state has a detrimental effect on workability. Further, the upper limit of the cross-sectional area is preferably about 1 cm². When the cross-sectional area is more than 1 cm², the presence of the fiber becomes local within the concrete, and therefore stable exploding resistance can be hardly attained. The length of the fiber composite is preferably a length 1.0 to 3.0 times longer than the maximum diameter of the aggregates used in the concrete.

Kinds of fiber used in the present invention are not limited as long as the fiber satisfies the value of the above tensile strength and the tensile modulus of elasticity. Examples of the fiber satisfying this value include an ultra high molecular weight polyethylene fiber, polybenzobisoxazole (PBO) fiber, aramide fiber, polyarylate fiber, and vinylon fiber as organic fibers, and a carbon fiber, glass fiber, boron fiber and alumina fiber as inorganic fibers, and a steel fiber and stainless fiber as metal fibers. Among these, an ultra high molecular weight polyethylene fiber is the most preferable. Since this fiber is stable in alkali, and does not produce corrosion such as rust, and has a high strength and a high modulus of elasticity and a small specific gravity, a light-weight concrete can be attained. However, since its heat resistance is low, the fiber having excellent heat resistance such as a PBO fiber or aramide fiber is preferably used when the concrete is cured at elevated temperatures in an autoclave.

The concrete of the present invention may be a concrete of only one layer, but if it is a structure of two or more layers, its exploding resistance is further improved. As described above, when explosion occurs near a concrete, the separated volume at the surface opposite to the surface facing the explosion is larger than that of the surface facing the explosion. By employing a concrete having a two-layer structure and using a concrete member used on the backside, whose bending strength is higher than that of a concrete used on the side facing explosion, a separated volume at the backside of the second layer can be reduced. Thereby, an effect of protecting lives of persons within the concrete structure is outstandingly improved.

Examples of a method of producing the concrete having a two-layer structure include a method in which concrete paste of the first layer is poured and then immediately concrete paste of the second layer is poured and cured to form single-piece construction, and a method in which concrete paste of the second layer is poured and cured when the first layer is half-cured.

Further, simply, two or more concrete plates may be produced separately and may be stacked to be used. Stacked concrete plates can be used in a wall or a ceiling of a structure, and by employing a structure of two or more concrete plates, the weight of a concrete plate can be decreased, and therefore the number of heavy equipment can be reduced or the number of working persons can be reduced in constructing the structure, and workability is improved and shortening of work periods becomes possible. In this case, the separated volume of the opposite surface of the surface facing the explosion can be reduced.

The plate thickness of the concretes to be stacked is preferably a length 1.5 times or more longer than the maximum diameter of the aggregates. Specifically, a thickness of 20 mm or more is preferable. When the thickness of plate is less than 20 mm, the concrete can cause quality troubles such that the concrete becomes cracked or becomes chipped or the concrete is broken in carrying or constructing the concrete. Further, the maximum thickness is not particularly specified, but it is preferably 500 mm or less due to manufacturing reasons.

The distance between plates in stacking the concrete plates is not particularly specified, but it is preferable that the gap is present. The distance of the gap (cushioning material layer) is preferably 3 mm or more and 300 mm or less, and more preferably 5 mm or more and 100 mm or less. Making an opening in the gap has an effect of interrupting the propagation of explosion energy being propagated from the surface facing blasting to the opposite surface and can reduce the separated volume of the opposite surface of a second concrete plate or a concrete plate farthest from the surface facing blasting.

Examples of a method of connecting the plate of a first layer to the plate of a second layer include a method of fixing two plates with nuts and bolts, a method in which concrete plates are bonded to a spacer using a resin to maintain a distance between the plate, and a method in which a frame of iron or the like is made in advance and concrete plates are fit into the frame in the case where the gap is small. Further, examples of this method also include a method in which the so-called blocks, which have such a structure that vertically two-layered concrete plates as a concrete secondary product are connected to each other with a hollow portion therebetween by a plurality of connecting portions, are produced, and these blocks are stacked and fastened with a binder such as mortar.

When the concrete plates are stacked, it is preferable to arrange concrete plates in such a way that a junction of adjacent concrete plates in the first layer and a junction of adjacent concrete plates in the second layer do not overlap one another. Since the junction of adjacent concrete plates has low exploding resistance compared with a central portion of the concrete plate, if the junction in the first layer overlaps the junction in the second layer, there is a possibility that performance fundamentally expected cannot be achieved in the vicinity of the junction. The distance as a guide by which the junctions are displaced from one another is 100 mm or more, and preferably 150 mm or more.

A gap between the stacked concrete plates may remain an empty space without filling the gap with something. Alternatively, a cushioning material having a static modulus of elasticity lower than that in a direction of the compression of a concrete may be filled into the gap. Hereinafter, a concrete member having a structure in which the cushioning material is filled into the gap between the stacked concrete plates is referred to as a concrete complex. If the cushioning material is filled into the gap between two concrete plates, this structure has the effect of reducing the destroyed volume of the concrete since energy produced in the explosion is absorbed. Examples of a material to be used in the cushioning material include mortar, concrete, and the like, but other materials, for example, a nonwoven fabric or a rubber material, may be used.

As for properties of a concrete material to be used in the cushioning material, a material having a static modulus of elasticity lower than that in a direction of the compression of the concrete having excellent exploding resistance of the present invention is preferable. For example, when the static modulus of elasticity in the direction of the compression of the concrete having excellent exploding resistance, which are used on the upside and downside, are 50 kN/mm², it is preferable that the static modulus of elasticity of the cushioning material is about 40 kN/mm² or less. From the results of Examples, even when the static modulus of elasticity of the concrete is 25 kN/mm² or less, the effect of reducing the destroyed volume of the concrete is achieved. A method of measuring the static modulus of elasticity of the concrete may be carried out according to JIS A 1149.

When a nonwoven fabric is employed as a cushioning material, it is considered that any nonwoven fabric can be inserted to achieve an effect as a cushioning material because nonwoven fabric has a smaller static compression coefficient than the concrete. However, in order to attain a higher cushioning effect, the weight of the nonwoven fabric per unit volume is preferably 250 kg/m³ or less. When the weight is 250 kg/m³ or more, the weight of the nonwoven fabric becomes heavy and a contribution to weight reduction becomes small. Further, since it is conceivable that explosion energy is consumed by cutting the fibers and thereby an object as a cushioning material can be achieved, the tensile strength of the nonwoven fabric is preferably 10 N/5 cm or more. When the tensile strength is 10 N/5 cm or less, handling becomes difficult. The weight per unit area and the strength can be determined according to JIS L 1096 and measuring methods specified in JIS L 1906. As the fibers composing the nonwoven fabric, all the aforementioned fibers can be employed.

When a rubber material is used for a cushioning material, all rubber can be used since rubber generally has smaller hardness than the concrete. However, since the use of special rubber may cause cost to increase, a rubber material having a hardness of 90 Hs or less is preferably used. The hardness of rubber can be measured with a spring type hardness testing machine (Durometer) according to a method of JIS K 6253.

A method of producing a structure using the concrete of the present invention is not particularly limited, and a method, in which a freshly mixed concrete is transported to the field with a agitating truck, and fibers are mixed in the freshly mixed concrete in the field to be agitated for several minutes, and the resulting mixture is casted in a desired location, may be employed, or a method of building up the concrete prepared in a factory in the field and filling a cushioning material may be employed.

Examples of the structures obtained from the concrete of the present invention include structures such as apartment houses and buildings, container-like structures such as warehouses, roads and air strips, quays and breakwaters of harbor, and generally produced secondary products, but the structure is not particularly limited to these. The concrete of the present invention can be applied to a structure for which the threat of blasting of explosives by terrorism is assumed.

### EXAMPLES

Hereinafter, the present invention will be described specifically by way of Examples.

### (Measurement of Property of Organic Fiber)

The tensile strength and the tensile modulus of elasticity of organic fibers of formed in the form of multifilament by binding monofilaments were measured with 5 t Tensilon manufactured by ORIENTEC Co., Ltd. The tensile strength and the tensile modulus of elasticity of a fiber composite were measured with 5 t Tensilon manufactured by ORIENTEC Co., Ltd.

### (Preparation of Test Specimen)

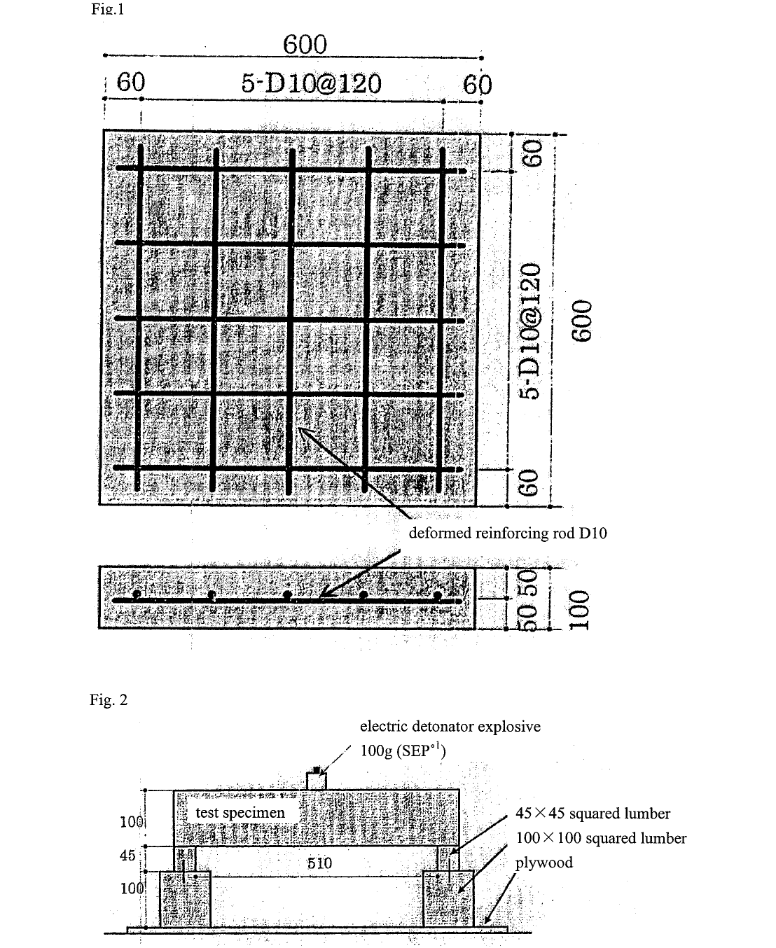

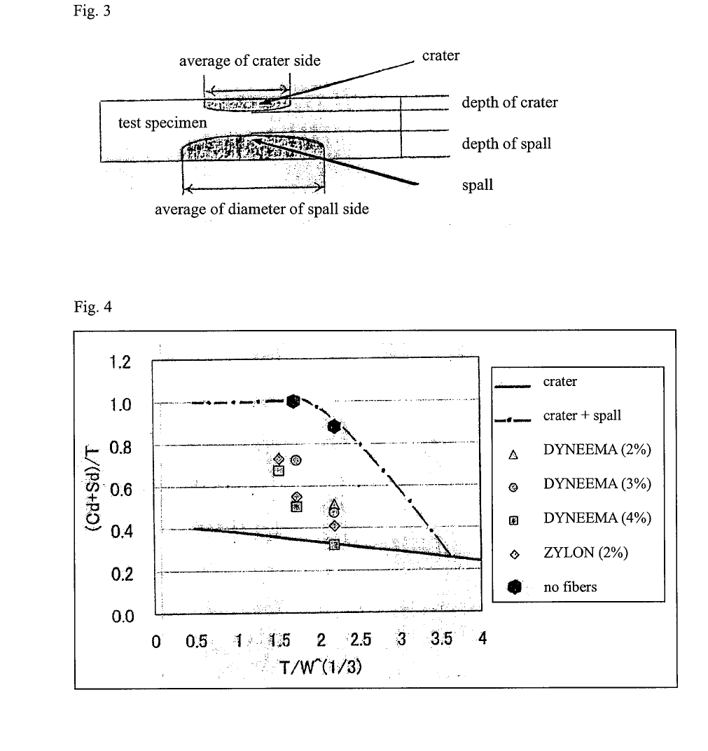

The composition of test specimens is as shown in Table 1 or Table 4. High early strength Portland cement (produced by TAIHEIYO CEMENT Corp.), blast furnace slag powder (ESMENT (registered trade mark) Super 60 produced by Nippon Steel Blast-Furnace Slag Cement Co., Ltd.), aggregate (fine aggregate having a maximum dimension of 2.5 mm and coarse aggregate having a maximum dimension of 15 mm), and a high-performance AE water reducing agent (MIGHTY (registered trade mark) 3000S produced by KAO Corp.) were put in a container, and the resulting mixture was kneaded for 30 sec as it was, and water was added to the mixture and this was kneaded for 90 sec, and fibers were added to the mixture and this was kneaded for 3 minutes to prepare a concrete test specimen. The size of the test specimen was 600 mm in length, 600 mm in width, and 100 mm in thickness. As shown in FIG. 1, five deformed reinforcing rods SD295A (D10) were arranged at 120 mm pitch in a vertical direction and lateral direction, respectively, at a center (50 mm in FIG. 1) in a thickness direction within the concrete. The concrete was covered with a wet cloth and further covered with a vinyl sheet for 14 days after casting to perform moisture curing, and thereafter air curing was performed for 14 days.

TABLE 1

| | W/B | Sg/B | S/(S + G) | Vf | Unit amount (kg/m³) | | | | | Sp/B | Slump |
|---|---|---|---|---|---|---|---|---|---|---|---|
| | (%) | (%) | (%) | (%) | C | Sg | W | S | G | (%) | (cm) |
| Example 1 | 33 | 50 | 65 | 2.0 | 488 | 488 | 325 | 550 | 339 | 0.25 | 23.3 |
| Example 2 | 33 | 50 | 65 | 4.0 | 448 | 448 | 325 | 550 | 339 | 0.10 | 25.7 |
| Example 3 | 33 | 50 | 65 | 2.0 | 448 | 448 | 325 | 550 | 339 | 0.10 | 26.4 |
| Example 4 | Examples 1 and 3 were used | | | | | | | | | | |
| Example 5 | 33 | 50 | 65 | 4.0 | 448 | 448 | 325 | 550 | 339 | 0.50 | 13.2 |
| Example 6 | 33 | 50 | 65 | 6.0 | 448 | 448 | 325 | 550 | 339 | 0.50 | 11.7 |
| Comparative Example 1 | Ready-mixed concrete was used | | | | | | | | | | 18 |
| Comparative Example 2 | 33 | 50 | 65 | 1.0 | 488 | 488 | 325 | 550 | 339 | 0.10 | 24.6 |
| Comparative Example 3 | 33 | 50 | 65 | 1.0 | 448 | 448 | 325 | 550 | 339 | 0.10 | 27.2 |
| Comparative Example 4 | 33 | 50 | 65 | 1.5 | 325 | 325 | 325 | 730 | 339 | 0.25 | 15.0 |
| Example 7 | 33 | 50 | 65 | 2.0 | 498 | 498 | 331 | 534 | 339 | 0.10 | 22.1 |
| Example 8 | | | | | | | | | | | |
| Example 9 | 33 | 50 | 65 | 4.0 | 448 | 448 | 325 | 550 | 339 | 0.50 | 12.5 |
| Example 10 | | | | | | | | | | | |
| Example 11 | 33 | 50 | 65 | 2.0 | 448 | 448 | 325 | 550 | 339 | 0.10 | 11.9 |
| Example 12 | | | | | | | | | | | |

| | | |
|---|---|---|
| Comparative Example 5 | Ready-mixed concrete was used | 18 |

C: cement, W: water, B: binder (C + Sg), Sg: blast furnace slag powder, Vf: fiber vol. %, S: fine aggregate, G: coarse aggregate, Sp: high-performance AE water reducing agent

### (Blasting Test)

The structure sustains an explosion load by the explosion of explosives, and when local damages of the structure sustaining this explosion load are considered, explosion sources may be classified broadly into three categories: the case where the explosion occurs at a location extremely close to the structure (proximity explosion), the case where the explosion occurs at the surface of the structure (contact explosion) and the case where the explosion occurs within the structure. Among these, since the contact explosion is used as a standard in another case as the damage evaluation of the structure is performed, the contact explosion test is also employed in the present invention.

A blasting work was performed by fixing the test specimen at a height of 14.5 cm above the ground (shown in FIG. 2) using two kinds of blocks, and setting up 100 g to 300 g of explosives at the center of the test specimen to explode them. The explosives used at this time was SEP (produced by Asahi Kasei Corp.) consisting of 65% of penthrite (PETN) and 35% of paraffin. As for properties of this explosive, the density was 1.3 g/cm³, and the explosion velocity was 6900 m/sec. Evaluation items of the separated portion after blasting were a diameter, a depth, and a volume. The diameter was measured in four directions of a longitudinal direction, a lateral direction, and both bias directions of the test specimen, and an average of these four diameters was designated as an average diameter. The depth was measured at the deepest position with a caliper. The separated volume was measured by filling water into the separated portion and the volume of water was determined. In addition, a separated volume portion on the side on which the explosives were set up is referred to as a “crater”, and a separated volume portion on the opposite side (opposite side of a concrete plate farthest from the surface facing explosion in the case of a concrete complex) thereof is referred to as a “spall”. The results of evaluations are summarized in Table 2.

### (Compressive Test and Bending Test)

A slump test, a compressive test, and a bending test were carried out on test specimens having the same composition (Table 1 and Table 4) as that of the test specimens of the blasting test. The slump test was carried out according to JIS A 1101. The compressive strength test was carried out according to JIS A 1108 by preparing a column test specimen of φ100 mm×200 mm. With respect to the bending test, a quadratic prism test specimen with a cross-section of 10 cm×10 cm and a length of 40 cm was measured by a central three point bending test (30 cm span) (central point loading test). The bending toughness was determined by designating an area between an origin and a displacement up to 1/150 of a span as bending toughness. These results are summarized in Table 2. The test results of the composition of Table 4 are described later.

By varying an amount and kinds of fiber, test specimens having different compressive strengths, bending strengths and bending toughness of the concrete were prepared. Blasting tests shown in Examples 1 to 6 and Comparative Examples 1 to 5 were carried out to determine a relationship between the properties of the concrete and the magnitude of the separated portion of the concrete.

### Example 1

High molecular weight polyethylene fibers (DYNEEMA (registered trade mark) produced by TOYOBO Co., Ltd.) of 2640 dtex (fineness of a single fiber is 1.1 dtex) were covered with multiple turns of 230 turn/m of a polypropylene thermally adhesive yarn (PYLEN (registered trade mark) produced by MRC PYLEN Co., Ltd.) of 760 dtex, and then a bundle of the polyethylene fibers was thermally set at 120° C. to obtain a yarn (fiber composite). The tensile strength of the above multifilament of 2640 dtex was 2.9 GPa, the tensile modulus of elasticity was 97 GPa, the tensile strength of the yarn was 1.9 GPa, and the tensile modulus of elasticity was 43 GPa. This yarn was cut into the length of 3 cm. A test specimen was prepared at the fiber mixing ratio of 2.0 vol. % using the composition shown in Table 1. The amount of explosive used in blasting was set at 100 g to perform a blasting test.

### Example 2

High molecular weight polyethylene fibers (DYNEEMA (registered trade mark) produced by TOYOBO Co., Ltd.) of 1320 dtex (fineness of a single fiber is 1.1 dtex) were impregnated with an epoxy resin and a bundle of the fibers impregnated with an epoxy resin was cured to obtain a yarn. Furthermore, the yarn was embossed to provide projections and depressions. The tensile strength of the above multifilament of 1320 dtex was 3.1 GPa, the tensile modulus of elasticity was 105 GPa, the tensile strength of the yarn was 2.3 GPa and the tensile modulus of elasticity was 48 GPa. In addition, the amount of the resin adhering to the yarn was 120% by weight. This yarn was cut into the length of 3 cm. A test specimen was prepared at the fiber mixing ratio of 4.0 vol. % using the composition shown in Table 1. The amount of explosive used in blasting was set at 100 g to perform a blasting test.

### Example 3

PBO fibers (ZYLON (registered trade mark) produced by TOYOBO Co., Ltd.) of 1110 dtex (fineness of a single fiber is 1.5 dtex) were covered with multiple turns of 150 turn/m of a polypropylene thermally adhesive yarn (PYLEN (registered trade mark) produced by MRC PYLEN Co., Ltd.) of 760 dtex, and then a bundle of the polyethylene fibers was thermally set at 120° C. to obtain a yarn. The tensile strength of the above multifilament of 1110 dtex was 5.9 GPa, the tensile modulus of elasticity was 218 GPa, the tensile strength of the yarn was 2.6 GPa, and the tensile modulus of elasticity was 85 GPa. This yarn was cut into the length of 3 cm. A test specimen was prepared at the fiber mixing ratio of 2.0 vol. % using the composition shown in Table 1. The amount of explosive used in blasting was set at 100 g to perform a blasting test.

### Example 4

Concrete paste having the same composition as in Example 1 was casted in a thickness of 50 mm, and shortly thereafter, concrete paste having the same composition as in Example 3 was casted on the above concrete paste in a thickness of 50 mm to prepare a test specimen. An explosive was set up on the surface of the concrete having the composition of Example 1 to perform a blasting test. The amount of explosive used in blasting was set at 100 g to perform a blasting test.

### Example 5

Using the cut yarn obtained in Example 1, a test specimen was prepared at the fiber mixing ratio of 4.0 vol. % using the composition shown in Table 1. The amount of explosive used in blasting was set at 100 g to perform a blasting test.

### Example 6

High molecular weight polyethylene fibers (DYNEEMA (registered trade mark) produced by TOYOBO Co., Ltd.) of 1320 dtex (fineness of a single fiber is 1.1 dtex) were covered with multiple turns of 150 turn/m of a polypropylene thermally adhesive yarn (PYLEN (registered trade mark) produced by MRC PYLEN Co., Ltd.) of 190 dtex, and then a bundle of the polyethylene fibers was thermally set at 120° C. to obtain a yarn. The tensile strength of the above multifilament of 1320 dtex was 3.1 GPa, the tensile modulus of elasticity was 105 GPa, the tensile strength of the yarn was 2.0 GPa, and the tensile modulus of elasticity was 46 GPa. This yarn was cut into the length of 3 cm. A test specimen was prepared at the fiber mixing ratio of 2.0 vol. % using the composition shown in Table 1. The amount of explosive used in blasting was set at 100 g to perform a blasting test.

### Comparative Example 1

A test specimen was prepared without mixing fibers in a ready-mixed concrete (guaranteed strength 30 N/mm², specified slump 18 cm; produced by AJIOKA NAMAKON COMPANY and ARIAKE NAMAKON COMPANY). The amount of explosive used in blasting was set at 100 g to perform a blasting test.

### Comparative Example 2

Using the cut yarn of 3 cm in length used in Example 1 and a test specimen was prepared at the fiber mixing ratio of 1.0 vol. % using the composition shown in Table 1. The amount of explosive used in blasting was set at 100 g to perform a blasting test.

### Comparative Example 3

Using the cut yarn of 3 cm in length used in Example 2 and a test specimen was prepared at the fiber mixing ratio of 1.0 vol. % using the composition shown in Table 1. The amount of explosive used in blasting was set at 100 g to perform a blasting test.

### Comparative Example 4

Net-like polypropylene fibers (length 55 mm) was added in an amount of 1.5 vol. %, and a test specimen was prepared using the composition shown in Table 1. As for properties of this fiber shown in the catalog, the tensile strength was 0.6 GPa and the tensile modulus of elasticity was 3.5 GPa. The amount of explosive used in blasting was set at 100 g to perform a blasting test.

The results of evaluations of Examples 1 to 6 and Comparative Examples 1 to 4 are shown in Table 2.

TABLE 2

| | Crater side (side on which | | | | | | | | | |
|---|---|---|---|---|---|---|---|---|---|---|
| | a high explosive is set up) | | | Spall side (opposite side) | | | | Compressive | | |
| | Average | Maximum | | Average | Maximum | | Compressive | strength/ | Bending | Bending |
| | diameter | depth | Volume | diameter | depth | Volume | strength | bending | strength | toughness |
| | (mm) | (mm) | (cm³) | (mm) | (mm) | (cm³) | (N/mm²) | strength | (N/mm²) | (kN · mm) |
| Example 1 | 122 | 33 | 119.1 | 58 | 20 | 169.5 | 65.8 | 9.6 | 6.88 | 28.90 |
| Example 2 | 132 | 30 | 123.5 | 61 | 18 | 170.1 | 59.0 | 6.3 | 9.41 | 36.80 |
| Example 3 | 119 | 30 | 114.9 | 38 | 11 | 141.9 | 64.8 | 8.5 | 7.60 | 30.3 |
| Example 4 | 129 | 26 | 125.0 | 30 | 8 | 76.5 | 64.1, 66.2 | 9.6, 8.5 | 6.71, 7.79 | 28.60, 30.60 |
| Example 5 | 126 | 32 | 98.8 | 0 | 0 | 0 | 57.8 | 5.2 | 11.20 | 46.30 |
| Example 6 | 107 | 28 | 53.5 | 0 | 0 | 0 | 55.1 | 4.1 | 13.41 | 58.90 |
| Comparative Example 1 | 154 | 34 | 283.5 | 277 | 61 | 1426.8 | 38.7 | 8.1 | 4.79 | 0.51 |
| Comparative Example 2 | 136 | 32 | 124.8 | 229 | 33 | 591.0 | 62.2 | 14.1 | 4.42 | 15.23 |
| Comparative Example 3 | 149 | 36 | 146.5 | 235 | 32 | 600.1 | 65.1 | 15.2 | 4.28 | 13.27 |
| Comparative Example 4 | 158 | 33 | 205.2 | 251 | 43 | 843.4 | 40.5 | 6.4 | 6.29 | 24.10 |

Next, by varying the amount of fibers to be mixed and the amount of explosives, blasting tests shown in Examples 7 to 12 and Comparative Example 5 were carried out to determine a relationship between the amount of explosives and the depth of concrete separation.

### Example 7

Using the cut yarn used in Example 1 and a test specimen was prepared at the fiber mixing ratio of 3.0 vol. % using the composition shown in Table 1. The amount of explosive used in blasting was set at 100 g to perform a blasting test.

### Example 8

Using the cut yarn used in Example 1 and a test specimen was prepared at the fiber mixing ratio of 3.0 vol. % using the composition shown in Table 1. The amount of explosive used in blasting was set at 200 g to perform a blasting test.

### Example 9

Using the cut yarn used in Example 1 and a test specimen was prepared at the fiber mixing ratio of 4.0 vol. % using the composition shown in Table 1. The amount of explosive used in blasting was set at 200 g to perform a blasting test.

### Example 10

Using the cut yarn used in Example 1 and a test specimen was prepared at the fiber mixing ratio of 4.0 vol. % using the composition shown in Table 1. The amount of explosive used in blasting was set at 300 g to perform a blasting test.

### Example 11

Using the cut yarn used in Example 3 and a test specimen was prepared at the fiber mixing ratio of 2.0 vol. % using the composition shown in Table 1. The amount of explosive used in blasting was set at 200 g to perform a blasting test.

### Example 12

Using the fiber used in Example 3, a test specimen was prepared at the fiber mixing ratio of 2.0 vol. % using the composition shown in Table 1. The amount of explosive used in blasting was set at 300 g to perform a blasting test.

### Comparative Example 5

Using the concrete of Comparative Example 1, and the amount of explosive used in blasting was set at 200 g to perform a blasting test.

The results of evaluations of Examples 7 to 12 and Comparative Example 5 are shown in Table 3.

TABLE 3

| | Maximum depth on | | | | | | |
|---|---|---|---|---|---|---|---|
| | crater side (side | Maximum depth on | | | | | Value of |
| | on which a high | spall side | Amount of | | | | (T/W^{1/3}) to |
| | explosive is set | (opposite side) | explosive | | (Cd + | | satisfy (Cd + |
| | up) (cm) | (cm) | (g) | T/W^{1/3} | Sd)/T | (Cd + Sd)/T = −a × (T/W^{1/3}) + b | Sd)/T = 1.0 |
| Example 7 | 3.3 | 1.4 | 100 | 2.19 | 0.40 | (Cd + Sd)/T = −0.98 × | 1.58 |
| Example 8 | 3.4 | 3.8 | 200 | 1.74 | 0.79 | (T/W^{1/3}) + 2.55 | |
| Example 5 | 3.2 | 0 | 100 | 2.19 | 0.32 | (Cd + Sd)/T = −0.51 × | 0.82 |
| Example 9 | 3.5 | 1.5 | 200 | 1.74 | 0.50 | (T/W^{1/3}) + 1.42 | |
| Example 10 | 3.9 | 2.8 | 300 | 1.52 | 0.74 | | |
| Example 3 | 3.0 | 1.1 | 100 | 2.19 | 0.28 | (Cd + Sd)/T = −0.46 × | 0.85 |
| Example 11 | 3.4 | 2.1 | 200 | 1.74 | 0.39 | (T/W^{1/3}) + 1.39 | |
| Example 12 | 3.9 | 3.4 | 300 | 1.52 | 0.58 | | |
| Comparative Example 1 | 3.4 | 5.4 | 100 | 2.19 | 0.87 | (Cd + Sd)/T = −0.51 × | 2.1 |
| Comparative Example 5 | 3.9 | 6.1 | 200 | 1.74 | 1.00 | (T/W^{1/3}) + 2.1 | |

Various experiments were carried out in the Defense Agency to derive a relational expression between a depth of concrete separation separated from a concrete exploded and an amount of explosives and this relational expression is plotted in a solid line. The results obtained in Examples and Comparative Examples this time are plotted similarly on FIG. 4.

As is apparent from Examples 1 to 6 and Comparative Examples 1 to 4, it was found that the concrete of the present invention has a high bending strength and a high bending toughness, and further can reduce an separated volume against the explosion of explosives in explosion-resistant performance, and particularly has the effect of reducing an separated volume of the opposite surface of the surface facing the explosion. Particularly, the test specimens of Examples 5 and 6, in which a large amount of fiber is mixed, did not produce separation on the spall side and produced just a plurality of cracks extending radially from a center of the test specimen.

As is apparent from Examples 7 to 12, Comparative Example 5 and FIG. 4, in the concrete of the present invention, a value of (T/W^{1/3}) satisfied the condition of (Cd+Sd)/T<−a×(T/W^{1/3})+b (a is an arbitrary number excluding 0, and b is an arbitrary number) within a range of 0.5 to 2.5, and therefore it is clear that explosion-resistant performance is improved compared with a concrete in which fibers are not mixed.

Next, concrete complexes (test specimens) were prepared by the use of two or more concretes varying a structure of stacking or a distance between stacked concretes. Blasting tests shown in Examples 13 to 20 and Comparative Example 6 were performed varying an amount of explosive to evaluate the sizes of separated portions of the concretes.

### Example 13

Using the cut yarn used in Example 1, test specimens of 50 mm in thickness were prepared in the same manner as in Example 1 using the composition shown in Table 4. Two test specimens were stacked without producing a gap to form a stacked plate of 10 cm in thickness. 200 g of an explosive was set up on a central portion of the stacked plate to perform a blasting test. The results of a slump test are shown in Table 4. A concrete obtained using the composition shown in Table 4 had a compressive strength of 59.4 N/mm², a bending strength of 9.40 N/mm², compressive strength/bending strength of 6.3, a bending toughness of 38.5 kN·mm, and a compressive static modulus of elasticity of 25.1 kN/mm².

### Example 14

Two test specimens prepared in Example 13 were fixed in such a way that the gap between the test specimens is 5 mm by interposing wood plates between the test specimens at both ends of the test specimens and bonding the wood plates to the test specimens with an adhesive. The gap is not filled with something and is just an air layer. 100 g of an explosive was set up on a central portion of the upper concrete of the concrete complex to perform a blasting test.

### Example 15

A test specimen was prepared in the same manner as in Example 14, and a blasting test was carried out by following the same procedure as in Example 14 except for changing the amount of the explosive to 200 g.

### Example 16

A test specimen was prepared in the same manner as in Example 14, and a blasting test was carried out by following the same procedure as in Example 14 except for changing the amount of the explosive to 300 g.

### Example 17

A test specimen was prepared in the same manner as in Example 14, and a mortar was filled into a gap. A static modulus of elasticity in a direction of the compression of this mortar was 22 kN/mm². A blasting test was performed with an explosive of 200 g.

### Example 18

A test specimen was prepared in the same manner as in Example 14, and nonwoven fabrics (VOLANS (registered trade mark) 4451NB produced by TOYOBO Co., Ltd.) made of polyester were stacked and filled into a gap so that the thickness was up to 5 mm. This nonwoven fabric had a weight per unit area of about 580 g/m² in the case of a thickness of 5 mm and a tensile strength of 1645 N/5 cm. A blasting test was performed with an explosive of 200 g.

### Example 19

A test specimen was prepared in the same manner as in Example 14, and rubber (porous chloroprene rubber) having a hardness of 70 HS was filled into a gap. A blasting test was performed with an explosive of 200 g.

### Example 20

Using the cut yarn used in Example 13 and test specimens were prepared at the fiber mixing ratio of 2.0 vol. % using the composition shown in Table 4. The plate thickness of the test specimen was 30 mm, and the gap between the plates was 5 mm, and wood plates were interposed between the test specimens at both ends of the test specimens in the same manner as in Example 14 and wood plates were fixed with an adhesive. A blasting test was performed with an explosive of 200 g.

### Comparative Example 6

A test specimen was prepared in the same manner as in Example 14, and a mortar was filled into a gap. The static modulus of elasticity in a direction of the compression of this mortar was 43 kN/mm² and was larger than that of the concrete. A blasting test was performed with an explosive of 200 g.

The characteristic values and the results of the blasting test of the test specimens of Examples 13 to 20 and Comparative Example 6 are shown in Table 5.

TABLE 4

| | W/B | Sg/B | S/(S + G) | Vf | Unit amount (kg/m³) | | | | | Sp/B | Slump |
|---|---|---|---|---|---|---|---|---|---|---|---|
| | (%) | (%) | (%) | (%) | C | Sg | W | S | G | (%) | (cm) |
| Example 13 | 33 | 50 | 65 | 2.0 | 488 | 488 | 325 | 550 | 339 | 0.25 | 21.8 |

C: cement, W: water, B: binder (C + Sg), Sg: blast furnace slag powder, Vf fiber vol. %, S: fine aggregate, G: coarse aggregate, Sp: high-performance AE water reducing agent

TABLE 5

| | | | | | Crater side (side on which a | | | | | |
|---|---|---|---|---|---|---|---|---|---|---|
| | | | | | high explosive is set up) | | | Spall side (opposite side) | | |
| | Amount of | Number of | Cushioning material layer | | Average | Maximum | | Average | Maximum | |
| | explosives | laminated | Thickness | | diameter | depth | Volume | diameter | depth | Volume |
| | (g) | layers | (mm) | Material | (mm) | (mm) | (cm³) | (mm) | (mm) | (cm³) |
| Example 13 | 200 | 2 | 0 | — | 127 | 36 | 171.0 | 154 | 22 | 420.0 |
| Example 14 | 100 | | 5 | Air | 127 | 50 | — | 0 | 0 | 0 |
| Example 15 | 200 | | 5 | Air | 123 | 50 | — | 111 | 19 | 387.1 |
| Example 16 | 300 | | 5 | Air | 136 | 50 | — | 187 | 31 | 519.6 |
| Example 17 | 200 | | 5 | Mortar | 123 | 50 | — | 108 | 20 | 389.9 |
| Example 18 | 200 | | 5 | Nonwoven fabric | 120 | 50 | — | 100 | 18 | 345.5 |
| Example 19 | 200 | | 5 | Rubber plate | 126 | 50 | — | 111 | 18 | 360.1 |
| Example 20 | 200 | 3 | 5 | Air | 123 | 50 | — | 0 | 0 | 0 |
| Comparative Example 6 | 200 | 2 | 5 | Mortar | 119 | 50 | — | 225 | 33 | 693.5 |

### INDUSTRIAL APPLICABILITY

In the present invention, a concrete obtained by mixing high-strength fibers has the effect of reducing the destroyed volume of the concrete in the explosion by the use of explosives. More specifically, upon explosion of an explosive material near a structure, a part of the structure is separated by explosion energy. In general, the separation of the structure on the side opposite to the side facing explosion is larger than that of the side facing explosion, and the separation on this side has a larger risk of injuring persons within the structure. Since the present invention has the effect of reducing a separated volume in the acts of blasting a concrete structure using explosives in the case of terrorism, it can be used as a member for lifesaving or for preventing the collapse of the structure.

Further, when two or more concretes are combined into one concrete complex, the concrete complex shows performance equal to or better than explosion-resistant performance of one concrete plate having the same thickness as that of the two or more concretes. Therefore, it becomes possible to reduce a weight of the concrete plate, and the number of heavy equipment, working days and working persons can be reduced. Further, by stacking two or more concretes, the extensive destruction of a structure by explosion by the use of explosives can be suppressed and injuries of persons within the structure can be prevented through inhibiting the flying of concrete broken pieces by a blasting impact.

Examples of the structures obtained from the concrete of the present invention include structures such as apartment houses and buildings, container-like structures such as warehouses, roads and air strips, quays and breakwaters of harbor, and generally produced secondary products, but the structure is not particularly limited to these, and the concrete of the present invention can be applied to a structure for which the threat of blasting of explosives such as terrorism is assumed.

1. A concrete material having excellent explosion resistance, comprising a fiber as a constituent material,
wherein said concrete material has a compressive strength of 50 N/mm² or more, a bending strength of 6 N/mm² or more, and a ratio of the compressive strength to the bending strength is 15 or less.

2. The concrete material of claim 1, wherein, in properties of a fiber used as the constituent material of the concrete, a tensile strength is 1.5 GPa or more, a tensile modulus of elasticity is 40 GPa or more, and a volume content of fibers in the concrete is 2.0% or more and 8.0% or less per 1 m³.

3. The concrete material of claim 1, wherein the concrete has a bending toughness of 25 kN·mm or more.

4. The concrete material of claim 1, wherein when 100 g of an explosive is in direct contact with the concrete of 50 mm in thickness and exploded, half or more of an original thickness of the concrete remains.

5. A concrete complex comprising two or more concrete materials of claim 1.

6. The concrete complex of claim 5, further comprising a cushioning material layer arranged between the two or more concrete materials.

7. The concrete complex of claim 6, wherein the cushioning material layer is an air layer.

8. The concrete complex of claim 6, wherein the cushioning material layer is made of a material having a compressive static modulus of elasticity lower than a compressive static modulus of elasticity of the concrete material having excellent explosion resistance.
